(19) United States
(12) Patent Application Publication
(10) Pub. No.: US 2021/0035347 A1
(43) Pub. Date: Feb. 4, 2021

(54) MODELING OF NONLINEAR SOFT-TISSUE DYNAMICS FOR INTERACTIVE AVATARS

(71) Applicant: SEDDI, INC., New York, NY (US)

(72) Inventors: Dan CASAS GUIX, Madrid (ES); Miguel Ángel OTADUY TRISTÁN, Madrid (ES)

(73) Assignee: SEDDI, INC., New York, NY (US)

(21) Appl. No.: 17/076,660

(22) Filed: Oct. 21, 2020

Related U.S. Application Data
(63) Continuation of application No. PCT/ES2018/070326, filed on Apr. 25, 2018.

(51) Int. Cl. G06T 13/40; G06T 17/20; G06T 7/70; G06N 3/08

(52) U.S. Cl. CPC G06T 13/40; G06T 17/20; G06T 2207/20084; G06N 3/08; G06T 2207/20081; G06T 7/70

(57) ABSTRACT

Computer models for bodies based on vertex-based models are enriched by adding nonlinear soft-tissue dynamics to the traditional piece-wise rigid meshes. A neural network is provided for real-time nonlinear soft-tissue regression to enrich skinned 3D animated sequences. The neural network is trained to predict 3D offsets from joint angle velocities and accelerations, as well as earlier dynamic components. The per-vertex rigidity is computed and leveraged to obtain a better-behaved minimization problem. A novel autoencoder is also provided for dimensionality reduction of the 3D vertex displacements that represent nonlinear soft-tissue dynamics in 3D mesh sequences.

### BACKGROUND

This disclosure generally relates to computer modeling systems, and more specifically to a system and method for learning and modeling the movement of soft-tissue on a 3-dimensional computer model of a body or object, such as a human, animated character, computer avatar, or the like.

In computer graphic applications, the accurate and life-like modeling of bodies, such as human bodies, has been a long-standing goal, and a key component for realistic character animation in video games, films, and other computer-modeling applications. For example, highly realistic 3D meshes representing the body of a person that look and behave as the human body does in the computer application are highly desirable. Such models must be able to represent different body shapes, deform naturally with pose changes, and incorporate non-linear surface dynamics that mimic the behavior and movement of soft skin in the outer shell of the body. For example, in a computer game application, such as an NFL Football simulation game, the models for different players would represent the body shapes typical of players for different positions. For example, the model for a quarterback would typically have a smaller and slender body shape as compared to the model for a defensive lineman, would have a bigger and stockier body shape. Ideally, the models for the different body shapes would behave differently for a given motion. For example, when simulating a jump, the slender body shape of a quarterback model should not have much soft-tissue motion as compared with the larger body shape of a defensive lineman model, whose muscles and overall outer body shapes would be expected to bounce upon landing back on the ground.

In interactive applications, such as computer games or other real-time modeling of body movement, there is often an additional goal of simplicity and efficiency to provide real-time responses, often requiring control of the body model using only its skeletal movement or pose, with the animation of the surface around the skeletal body modeled as a function of the skeletal pose. Some computer animation methods define the body surface as a kinematic function of skeletal pose that blends rigid transformations of skeletal bones but do not provide an efficient approach to model the nonlinear soft-tissue dynamics and thus are not as compelling.

What is needed, are more complex transformations that incorporate actual body surface data into the model, including the nonlinear dynamics of the body's surface, caused by the oscillation of soft tissue under fast skeletal motion and that can be used in existing efficient vertex-based animation pipelines suited for interactive applications.

### BRIEF SUMMARY

According to various embodiments of the present invention, systems and methods for the learning and modeling of soft-tissue dynamics in a three-dimensional computer model of a body or object are provided.

According to one embodiment, a system comprises a surface skinning module for adding skin surface elements to a frame of skeletal input representative of a pose of the body. The system also includes a soft-tissue regression module configured to add nonlinear soft-tissue dynamics to the skin surface elements and provide an output mesh representative of the body at the pose in the skeletal input. In this embodiment, the soft-tissue regression module comprises a neural network trained from observations to predict 3-dimensional offsets.

In alternative embodiments the body may correspond to a human body, an animal body, a character in a movie, a character in a video game, or an avatar. For example, the avatar may represent a customer.

According to another embodiment, the system further comprises an autoencoder module configured to reduce by two or more orders of magnitude the dimensionality of a plurality of three-dimensional offsets for a plurality of vertices in the skin surface elements. In this embodiment, the autoencoder module comprises a combination of linear and non-linear activation functions. In one embodiment, the autoencoder module comprises at least three layers, wherein at least two non-successive layers comprise non-linear activation functions.

According to an aspect of various embodiments, the neural network may be trained from a set of observations in a set of three-dimensional input meshes representative of a plurality of poses for a reference body. The autoencoder module may also be trained from a set of observations in a set of three-dimensional input meshes representative of a plurality of poses for a reference body.

According to an aspect of various embodiments, the neural network in the soft-tissue regression module is trained to predict 3-dimensional offsets from velocities and accelerations derived from prior frames of the skeletal input. According to another aspect of various embodiments, the soft-tissue regression module is configured to add the nonlinear soft-tissue dynamics to the skin surface elements using the output of the one or more activation functions.

According to an alternative embodiment, the computer-based modeling may be include adding skin surface elements to a frame of skeletal input representative of a pose of the body. The dimensionality of a plurality of three-dimensional offsets for a plurality of vertices in the skin surface elements is reduced by two or more orders of magnitude by applying at least one non-linear activation function. The resulting output mesh representative of the body at the pose in the skeletal input is provided.

According to this embodiment, nonlinear soft-tissue dynamics may be added to the skin surface elements. For example, adding the nonlinear soft-tissue dynamics may include a neural network trained from observations to predict 3-dimensional offsets.

According to another embodiment, the reducing step comprises applying at least three layers of activation functions, wherein at least two non-successive layers comprise non-linear activation functions.

According to another embodiment, the body corresponds to a human body, an animal body, a character in a movie, a character in a video game, or an avatar. For example, the avatar may represent a customer.

### BRIEF DESCRIPTION OF THE SEVERAL VIEWS OF THE DRAWINGS

FIG. 1 illustrates an exemplary learning-based system to augment a skinning-based character animation with realistic nonlinear soft-tissue dynamics according to one embodiment of the disclosure.

FIG. 2 is a functional block diagram of a method for producing a mesh output with enriched soft-tissue dynamic modeling according to one embodiment of the disclosure.

FIG. 3A is an illustration of a fitted result to a scan and illustrating the differences in the pose state according to one embodiment.

FIG. 3B is an illustration of a fitted result to a scan and illustrating the differences in the unposed state according to one embodiment FIG. 4 is a functional diagram of the stages of an autoencoder according to one embodiment.

FIG. 5 is a chart with plots of the per-vertex mean error of the reconstructed meshes of the sequence 50002_running_on_spot according to one embodiment.

FIG. 6A is an illustration of a reconstructed dynamic blendshape from sequence 50004_one_leg_jump of the test 4D dataset (Dyna) in multiple dimensional spaces according to one embodiment.

FIG. 6B is an illustration of the per-vertex error visualized as a colormap of a reconstructed dynamic blendshape from sequence 50004_one_leg_jump of the test 4D dataset (Dyna) in multiple dimensional spaces according to one embodiment.

FIG. 7A is a chart with plots of the mean per-vertex error of the model for the 50004_one_leg-jump frame of the 4D scans of the Dyna dataset compared to SMPL according to one embodiment.

FIG. 7B is a chart with plots of the mean per-vertex error of the model for the 50004_running_on_spot frame of the 4D scans of the Dyna dataset compared to SMPL according to one embodiment.

FIG. 7C is a chart with plots of the mean per-vertex error of the model for the 50004_jumping_jacks frame of the 4D scans of the Dyna dataset compared to SMPL according to one embodiment.

FIG. 8 is an illustration providing a visual comparison of SMPL results and modeling results according to the disclosed embodiments with respect to a 4D scan ground truth sequence.

FIG. 9 is an illustration of dynamic sequences created from skeletal MoCap data using SMPL and the disclosed simulation methodology according to one embodiment.

FIG. 10 is another illustration of dynamic sequences created from skeletal MoCap data using SMPL and the disclosed simulation methodology according to one embodiment.

The figures depict various example embodiments of the present disclosure for purposes of illustration only. One of ordinary skill in the art will readily recognize form the following discussion that other example embodiments based on alternative structures and methods may be implemented without departing from the principles of this disclosure and which are encompassed within the scope of this disclosure.

### DETAILED DESCRIPTION

The above and other needs are met by the disclosed methods, a non-transitory computer-readable storage medium storing executable code, and systems for 3D modeling of bodies and similar shapes in computer applications, including, for example, motion capture applications, biomechanics and ergonomics design and simulation, education, business, virtual and augmented reality shopping, and entertainment applications, including animation and computer graphics for digital movies, interactive gaming and videos, human, animal, or character simulations, virtual and augmented reality applications, robotics, and the like.

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The systems and methods according to the various embodiments described enrich existing vertex-based models, for example for human-body modeling, such as LBS or SMPL. One example of such vertex-based models is described in SMPL: A Skinned Multi-Person Linear Model by Matthew Loper, Naureen Mahmood, Javier Romero, Gerard Pons-Moll, and Michael J. Black, incorporated herein by reference. See ACM Trans. Graphics (Proc. SIGGRAPH Asia) 34, 6 (2015), 248:1-248:16. According to one embodiment, a method regresses dynamic blendshapes to add nonlinear soft-tissue dynamics to the traditional piece-wise rigid meshes. A neural network-based solution for real-time nonlinear soft-tissue regression is provided to enrich skinned 3D animated sequences. The neural network is trained to predict 3D offsets from joint angle velocities and accelerations, as well as earlier dynamic components. A loss function is tailored to learn soft-tissue deformations. The per-vertex rigidity is computed and leveraged to obtain a better-behaved minimization problem. For higher efficiency, in one embodiment, a novel autoencoder is provided for dimensionality reduction of the 3D vertex displacements that represent nonlinear soft-tissue dynamics in 3D mesh sequences. In one embodiment, the autoencoder is used to reduce the dimensionality of the per-vertex 3D offsets by two or more orders of magnitude. In alternative embodiments, the autoencoder can reduce the dimensionality in both a preset or a configurable manner, including dynamically changeable manner adaptable to the particular needs for the given embodiment.

After applying the described method, the resulting subspace for soft-tissue dynamics overcomes existing methods, such as those based on Principal Components Analysis (“PCA”), for example as described in SMPL (above) or Dyna, (Gerard Pons-Moll, Javier Romero, Naureen Mahmood, and Michael J Black. 2015. Dyna: A model of dynamic human shape in motion. ACM Transactions on Graphics, (Proc. SIGGRAPH) 34, 4 (2015)). The resulting system better captures the nonlinear nature of soft-tissue dynamics.

According to one embodiment, nonlinear soft-tissue real-time dynamics in 3D mesh sequences are animated with a data-driven method based on just skeletal motion data. In one embodiment, skeletal motion data from the Carnegie Mellon University Mocap Database was used (CMU. 2003. CMU: Carnegie-Mellon Mocap Database. In http://mocap.cs.cmu.edu). In another embodiment, the “Total Capture” data set was used. See Matthew Trumble, Andrew Gilbert, Charles Malleson, Adrian Hilton, and John Collomosse. 2017. Total Capture: 3D Human Pose Estimation Fusing Video and Inertial Sensors. In BMVC17. The description of both of these datasets is incorporated herein by reference. In alternative embodiments, different skeletal motion data sets may be used within the scope of the invention for learning, training, or benchmarking among other functions.

According to one embodiment the body surface of a target body, such as virtual football player in a game, a character in a movie, a virtual shopper avatar in an online store or the like, is defined as a kinematic function of skeletal pose. To accomplish this, first linear blend skinning (LBS) methods are used to blend rigid transformations of skeletal bones. This technique, which is limited to a single human shape, attaches an underlying kinematic skeleton into a 3D mesh, and assigns a set of weights to each vertex that define how the vertices move with respect the skeleton. Despite being largely used in video games and films, LBS has two significant limitations: first, articulated areas often suffer from unrealistic deformations such as bulging or candy wrap effect; second, resulting animations are piece-wise rigid and therefore lack surface dynamics. LBS deformation artifacts have been addressed by different solutions, including dual quaternion [Kavan et al. 2008], implicit skinning [Vaillant et al. 2013] and example-based methods [Kry et al. 2002; Le and Deng 2014; Lewis et al. 2000; Wang and Phillips 2002], but these solutions ignore the LBS shortcomings due to shape and motion dynamics addressed in various embodiments of the present invention.

Scanning-based models have more recently been adopted with the availability of 3D capturing systems. Using 3D scans of a body, data-driven models use scanning and registration methods that are more accurate [Bogo et al. 2014, 2017; Budd et al. 2013; Huang et al. 2017]. Allen et al. [2002] described how to deform an articulated model into a set of scans in different poses, and then to predict new poses by mesh interpolation. Different statistical body models such as SCAPE [Anguelov et al. 2005] and the follow up works of Hasler et al. [2009], Hirshberg et al. [2012] and Chen et al. [2013] were described. These models learned from 3D scans are based on triangle transformations, which are more expensive to compute than vertex-based models and require more computing power. While capable of representing changes due to pose and shape, these models cannot cope with deformations due to non-rigid surface dynamics. More recently, Loper et al. [2015] proposed SMPL, a vertex-based method that computes pose and shape blendshapes that generate articulated 3D meshes by adding vertex displacements to a template mesh. Similarly, data-driven models capable of coping with some human body dynamics have been proposed, such as for example, Dyna [Pons-Moll et al. 2015]. Dyna models shape, pose and soft-tissue dynamics learned from thousands of 4D scans. However, as SCAPE, Dyna is based on triangle deformations which hinders the implementation of its method in existing vertex-based pipelines such as LBS. DMLP, an extension of SMPL [Loper et al. 2015], also models dynamics. However, the solution relies on a PCA subspace that hinders the learning of nonlinear deformations. In contrast, in some embodiments of the present invention, animations with soft-tissue dynamics using skeletal data are provided from publicly available MoCap datasets [CMU 2003; Trumble et al. 2017]. In some embodiments, an autoencoder is provided to build a richer nonlinear subspace that significantly reduces the dimensionality of dynamic blendshapes to improve over prior approaches.

Further, a strong limitation of these prior data-driven models is the inherent difficulty to represent deformations far from the training set. Physics-based models overcome this limitation but are significantly more complex and usually require a volumetric representation of the model. For example, Kadlecek et al. [2016] compute a fully physics-based subject-specific anatomical model, including bones, muscle and soft-tissue; Kim et al. [2017] combine data-driven with physics-based models to create a layered representation that can reproduce soft-tissue effects. These physics-based approaches fit the model to captured 4D scans to find subject-specific physical parameters. The use of layered representations consisting of a skeleton that drives physics-based soft-tissue deformations has been proposed in earlier works [Capell et al. 2002]. Liu et al. [2013] propose a pose-based plasticity model to obtain skinned deformation around joints. Hahn et al. [2012; 2013] enrich standard LBS animations by simulating the deformation of fat and muscles in the nonlinear subspace induced by its rig. Xu and Barbic̆ [2016] use secondary Finite Element Method (FEM) dynamics to efficiently add soft-tissue effects. Subspaces of deformations have also been explored for both characters [Kim and James 2012; Kry et al. 2002] and cloth [De Aguiar et al. 2010]. According to one embodiment, an enriched skinned model is provided with motion-dependent deformations of soft-tissues to simulate the body dynamics. However, instead of physics-based algorithms, which are computationally expensive, the soft-tissue deformations are automatically learned with a neural network trained purely from observations and can, for example, be produced in real-time applications without significant lag or delay.

Referring now to FIG. 1, according to one embodiment, a learning-based system 100 is provided to augment a skinning-based character animation with realistic nonlinear soft-tissue dynamics. A runtime pipeline 120, takes as input a skeletal animation S 101, obtained, for example, using motion capture or by editing a rigged character, avatar, or other body. For each frame of the skeletal animation 101, the system 100 produces the animation of the character's surface mesh M 108, including effects of nonlinear soft-tissue dynamics. The runtime pipeline 120 includes three main blocks: an auto-encoder 121, a soft-tissue regression module 122, and a skinning module 123.

Referring back to FIG. 1, according to one embodiment, a skinning model combines a (static) shape representation β 102, a skeletal pose θₜ 104 for the current frame t, and dynamic soft-tissue displacements Δₜ 103 to produce the deformed surface mesh Mₜ 108.

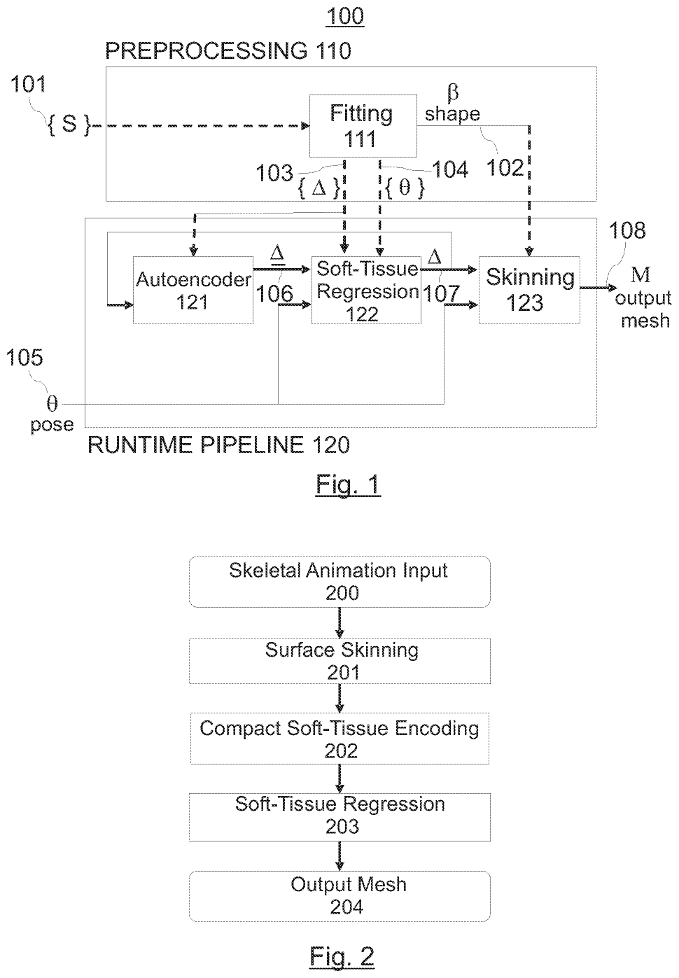

Referring now also to FIG. 2, it illustrates a method for a real-time modeling pipeline 120 according to one embodiment illustrated in FIG. 1, where a skeletal animation is input 200 and undergoes surface skinning 201. Compact soft-tissue is encoded 202, and a soft-tissue regression step 203 is performed to provide an output mesh 204. According to one embodiment, the dynamic soft-tissue displacements are represented in the undeformed pose space. Conventionally, a naïve design of dynamic soft-tissue regression would suffer from the curse of dimensionality, due to the large size of the soft-tissue displacement vector. However, in one embodiment, a compact subspace representation of dynamic soft-tissue displacements is obtained using a nonlinear autoencoder. For each frame, the autoencoder encodes 202 dynamic soft-tissue displacements Δₜ 103 into a compact subspace representation Δₜ 106.

The nonlinear soft-tissue dynamics are then solved as a nonlinear regression 203. Modeling soft-tissue dynamics involves capturing the nonlinear interplay of surface displacements, velocities, and accelerations, with skeletal pose, velocity and acceleration. In one embodiment, this complex nonlinear function is modeled using a neural network. The neural network outputs the current dynamic soft-tissue displacement Δₜ, and it takes as input the skeletal pose of the current frame θₜ and a number of previous frames, such as for example the two prior frames θₜ₋₁ and θₜ₋₂, to capture skeletal velocity and acceleration. In addition, the neural network takes also as input the compact soft-tissue displacements of a corresponding number of previous frames, such as for example the two previous frames Δₜ₋₁ and Δₜ₋₂, to capture soft-tissue velocity and acceleration. In alternative embodiments, different numbers of previous frames may be used to derive skeletal and soft-tissue velocity and acceleration. Alternatively, the number of previous frames used to derive velocity and acceleration may be dynamically and adaptively modified at runtime depending on the specific application.

Referring back to FIG. 1, in one embodiment, a preprocessing stage 110 includes a fitting module 111. The fitting module 111 takes as input a sequence of surface meshes of the character, {S} 101, which span its dynamic behavior. The preprocessing stage 110 involves fitting the surface skinning model and extracting the dynamic soft-tissue deformation, together with training the autoencoder and the neural network.

In one embodiment, the skinning module 123 includes a data-driven vertex-based linear skinning model. For example, in one embodiment, an SMPL-based model may be used as further described by Loper et al. (2015) (incorporated herein by reference). In an SMPL-based model, corrective blendshapes may be learned from thousands of 3D body scans and may be used to fix well-known skinning artifacts such as bulging. Formally, SMPL defines a body model surface M=M(β, θ) as:

M(β,θ)=W(M̅(β,θ),J(β),θ,W) [Eq. 1]

M̅(β,θ)=T̅+Mₛ(β)+Mₚ(θ) [Eq. 2]

where W(T̅, J, θ, W) is a linear blend skinning function [Magnenat-Thalmann et al. 1988] that computes the posed surface vertices of the template T̅ according to the joint locations J, joint angles θ and blend weights W. The learned functions Mₛ(β) and Mₚ(θ) output vectors of vertex offsets (the corrective blendshapes) that, applied to the template T̅, fix classic linear blend skinning artifacts as further described in Loper et al. (2015).

According to another aspect of this embodiment, the vertices of T are deformed such that the resulting posed reproduces realistic soft-tissue dynamics. Following SMPL additive blendshape formulations, a set of per-vertex 3D offsets is determined as Δ={δi}V−1 i=0 (which we refer to as dynamic blendshape) that added to the template model T̅ produces the desired deformation to the posed 3D mesh. We therefore extend the body model with an extra blendshape:

M̅(β,θ,γ)=T̅+Mₛ(β)+Mₚ(θ)+M_{d}(γ) [Eq. 3]

where M_{d}(γ)=Δ is a function that regresses the per-vertex offsets Δ given a history of previous frames motion and dynamics γ, as further described below. Unlike the use of corrective blendshapes mentioned in DMPL [Loper et al. 2015], the blendshapes according to this embodiment do not rely on a linear PCA subspace and generalize to arbitrary skeletal motions.

Further, unlike DMPL, this embodiment uses a nonlinear subspace, which is easier to train, allows real-time interactions, and has been successfully applied to existing motion capture datasets.

According to one embodiment, the dynamic blendshapes enable the computation of skin deformations resulting from interactions between the human body and external objects, such as cloth. These deformations are relevant, for example, in virtual try-on applications, such as online or remote e-commerce applications or garment design applications, where it is beneficial to have a realistic virtual fit of garments on a customer, for example using a model or avatar.

For example, according to one embodiment, a customer using an online shopping platform wants to get a preview of the fit of a garment before making a purchase decision. Dynamic blendshapes produce the soft-tissue deformations resulting from cloth-body contact.

According to this embodiment, to compute the interaction between body and cloth, a conservative contact potential is defined and forces generated by the dynamic motion of the skin on the cloth are computed as gradients of this potential. The per-vertex displacements caused by these forces are computed by integrating the resulting accelerations. For example, in every animation or simulation frame, a signed distance field of the body surface is computed with a small offset delta. For each cloth simulation node, the distance field is queried and a penetration value d is obtained. If the penetration is positive, a potential

$$φ = \frac{k \cdot {d}^{2}}{2}$$

is defined. Then, forces on cloth nodes and surface vertices are computed as

$$F = - \frac{d φ}{dx} .$$

For each simulation node or cloth vertex, with mass m, its acceleration correction is computed as

$$a = \frac{F}{m} .$$

Finally, a position correction

$$dx = \frac{a \cdot {dt}^{2}}{2}$$

is computed by second-order integration of the acceleration, where dt is the simulation time step.

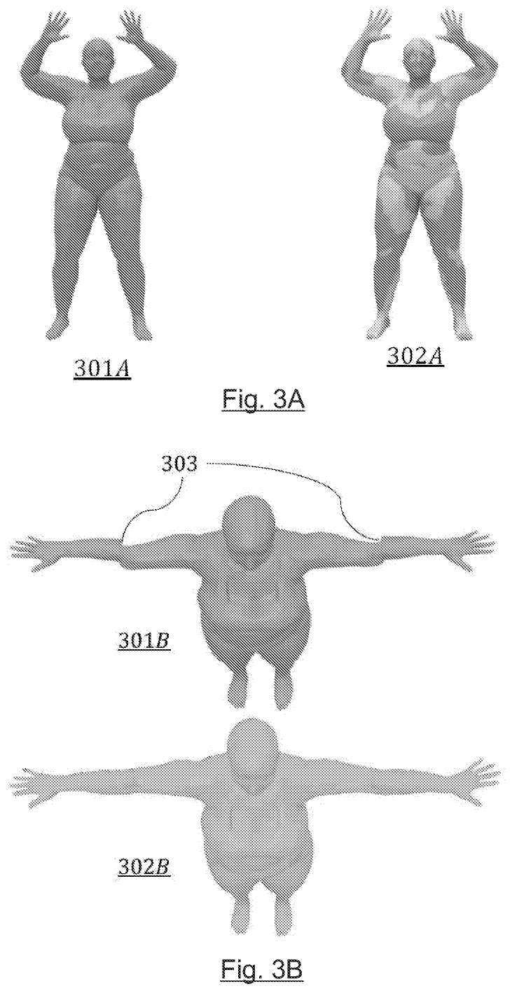

Referring back to Eq. 3, according to one embodiment, a supervised learning method is used to learn M_{d}(γ), using a neural network. Ground truth annotated data for training the neural network may be obtained from observations, manual annotation or physical simulations. According to one embodiment, as training data, recent methods in 4D capture [Bogo et al. 2017; Budd et al. 2013; Huang et al. 2017; Pons-Moll et al. 2015] that accurately fit and deform a 3D mesh template to reconstruct human performances, may be used. For example, in one embodiment, the publicly available aligned 4D scans dataset of Dyna [Pons-Moll et al. 2015], which captures highly detailed surface deformations at 60 fps, is used as training data for the neural network. Assuming that such 4D scans reproduce the captured surface with negligible error, the soft-tissue dynamic component can be extracted by fitting a shape and pose parametric model defined in Eq. 1 to the scans, and subsequently evaluating the differences between the fitted model and the 4D scan [Kim et al. 2017]. To this end, we find the parameters β, θ by minimizing the following:

$${arg min}_{β , θ} {\sum }_{i = 1}^{V} {w}_{i} {‖ unpose ( {M}_{i} ( β , θ ) ) - unpose ( {M}_{i} ( S , θ ) ) ‖}_{2}^{2} \qquad [ Eq . 4 ]$$

where unpose (·) is the inverse of the SMPL skinning function that puts the mesh in rest pose, and removes pose and shape corrective blendshapes; Mᵢ(·) is the ith vertex of the mesh; wᵢ is a weight that is set to high values in rigid parts; and S∈ [symbol] ^{V×3} is a matrix of vertices of the captured scan. Unlike other approaches, such as Kim et al. [2017], according to this embodiment, the minimization is performed at the unposed state. This achieves better results than minimizing the difference at the pose state, because ultimately the fit has to be unposed to compute the ground truth dynamic blendshape. If the minimization happens at the pose state, it is likely that despite achieving a close fit, when the scan S is unposed unrealistic deformations appear if the joint positions were not correctly fitted, as illustrated in FIG. 3A and FIG. 3B. FIG. 3A illustrates a fitted result to a scan S (blue) minimizing the differences in the pose state (red) 301A and in the unposed state (green) 302A. Both fittings look plausible when looking at the pose state (FIG. 3A), but the unposed scan S shown in FIG. 3B suffers from unrealistic deformations 303 when using the fit 301B obtained from minimizing the pose state as compared with the fit obtained from minimizing the unposed state 302B. According to one embodiment, to put the 4D scans in rest pose and to remove the effect of the SMPL corrective blendshapes due to pose and shape, Eq. 4 is solved and all frames Sₜ of the dataset are unposed with the optimize per-frame θₜ. The residual deformations in the unposed meshes,

Δₜ=unpose(M(β,θₜ))−unpose(M(Sₜ,θₜ)) [Eq. 5]

Δₜ ∈ [symbol] ^{V×3}, are due to soft tissue deformation, i.e. the dynamic blendshapes. Such blendshapes, together with the extracted θₜ and β are our ground truth data that we use for training the regressor M_{d}(γ) from Eq. 3

For a data-driven body model, an initial dimensionality

reduction step may be used to reduce the complexity of data representation. For example, Principal Component Analysis (“PCA”) methods, such as those described in Anguelov et al. 2005; Feng et al. 2015; Loper et al. 2015; Pons-Moll et al. 2015, provide a linear method that reproduces changes due to shape in a lower space. Similar linear models can be used for other applications, such as, cloth simulation, e.g., De Aguiar et al. 2010, skinning, e.g., James and Twigg 2005 and Kavan et al. 2010; and physics-based simulations, e.g., Barbic̆ and James 2005.

However, such PCA-based linear methods cannot properly represent soft tissue deformations in detail given the high non-linearity nature of the dynamic soft tissue data stored in Δ. Therefore, in one embodiment an autoencoder is used to provide a nonlinear method that has shown to perform better than PCA-based methods in dimensionality reduction capabilities in different fields as illustrated in Hinton and Salakhutdinov 2006. Autoencoders according to various embodiments of the invention approximate an identity mapping by coupling an encoding block with a decoding block to learn a compact intermediate representation, which may be referred to as the latent space. Particularly, each block consists of a neural network, with different hidden layers and non-linear operators. After training the neural network, a forward pass of the encoder converts the input to a compact representation. For example, FIG. 4 illustrates an autoencoder 400 according to one embodiment of the disclosure. In this embodiment, a vectorized version of the dynamic blendshape Δ∈ [symbol] ^{6890·3} is input to the encoder 401. The encoder 401 in this embodiment includes three layers with linear, nonlinear, and linear activation functions, respectively. In alternative embodiments different numbers of layers with other combinations of linear and nonlinear activation functions may be used. The encoder 401 outputs a vector Δ∈ [symbol] ¹⁰⁰ achieving a several orders of magnitude dimensionality reduction. As further explained below, due to the nonlinear activation functions in the layers of the encoder 401, we obtain a latent space capable of better reproducing the complexity of soft-tissue dynamics.

According to another aspect of one embodiment, a neural network is provided that automatically learns from observations, such as for example 4D scans, the function M_{d}(γ)=Δ as shown in Eq. 3. In particular, in one embodiment, M_{d}(γ) is parameterized by γ={Δₜ₋₁, Δₜ₋₂, θₜ, θₜ₋₁, θₜ₋₂}, where Δₜ₋₁, Δₜ₋₂ are the predicted dynamic blendshapes of previous frames. While in this embodiment two frames are used for illustration, any number of previous frames may be used in alternative embodiments. Notice that Δₜ ∈ [symbol] ^{6890·3} is a prohibitively expensive size for an efficient neural network input, and therefore the dimensionality of the vectorized input is reduce using an autoencoder as illustrated in FIG. 4. This dimensionality reduction efficiently finds a latent space to encode the nonlinear information. The input vector to the neural network is thus redefined as γ={Δₜ₋₁, Δₜ₋₂, θₜ, θₜ₋₁, θₜ₋₂}, using the dimensionally reduced blendshapes of previous frames.

According to another aspect of one embodiment, a neural network training method is provided. As described above, the dynamic blendshapes Δₜ and the pose and shape parameters (β, θₜ) are extracted from a given known set of 4D scans S={Sₜ}ₜ₋₁^{T}. Then a single-layer neural network is trained to learn to regress Δₜ from γ. In one embodiment, each neuron in the network uses a Rectified Linear Unit (ReLU) activation function, which provides a fast converging non-linear operator. In addition, a history of the previous dynamic components is fed to the network to predict the current dynamic blendshape in order to learn a regressor that understands second order dynamics. The blendshape predictions according to this embodiment are much more stable and produce an overall realistic nonlinear behavior of the soft tissue simulations.

Another aspect of embodiments for training neural networks according to the invention includes an appropriate loss function. In one embodiment it is desirable to minimize the euclidean distance between vertices of a ground truth dynamic blendshape Δ^{GT}={δᵢ^{GT}}ᵢ₌₁^{V} and the predicted dynamic blendshapes Δ. To do so, the following [symbol] 2-norm is minimized:

Loss=Σᵢ₌₁^{V}∥wᵢ^{rig}·(δᵢ^{GT}−δᵢ)∥₂ [Eq. 6]

where wᵢ^{rig} is the i^{th} vertex rigidity weight, inversely proportional to the vertex stiffness. By adding such weights, we enforce the optimizer to prioritize the learning on the non-rigid areas, such as breast and belly, over almost rigid areas, such as the head. We precompute wᵢ^{rig} automatically from data, also using the input 4D scans, as

$${w}_{i}^{rig} = \frac{{\sum }_{t = 1}^{T} {‖ {\dot{v}}_{i , t} - {\dot{v}}_{i , t - 1} ‖}_{2}}{T} \qquad [ Eq . 7 ]$$

where \dot{v}_{i,t} is the velocity of the i^{th} vertex of the ground truth blendshape Δᵢ^{GT}, and T the number of frames.

Thus, according to one embodiment, to process a pose model parameterized by |θ|=75 DOFs, and an autoencoder latent space of 100 dimensions, a single-layer neural network takes an input vector γ∈ [symbol] ³⁵⁰(100+100+75+75=350) and produces an output vector Δ∈ [symbol] ¹¹⁶⁷⁰(3890· [symbol] 3=11670). In this embodiment, the neural network includes \sqrt{|γ|·|Δ|}=2689 neurons in the hidden layer.

One embodiment of the present invention was qualitatively and quantitatively evaluated at the different stages of the system and method illustrated by this disclosure, including an autoencoder and a soft-tissue regressor. The inventors further generated a video of a simulation generated using one embodiment of the invention that shows compelling enriched animations with realistic soft-tissue effects. For training and testing both the autoencoder and the soft-tissue regressor in this experimental embodiment, the 4D dataset provided in the original Dyna paper [Pons-Moll et al. 2015] was used.

### Sample Autoencoder Evaluation

The performance of an autoencoder according to one embodiment was evaluated for dynamic blendshapes by leaving ground truth sequences 50002_running_on_spot and 50004_one_leg_jump out of the training set.

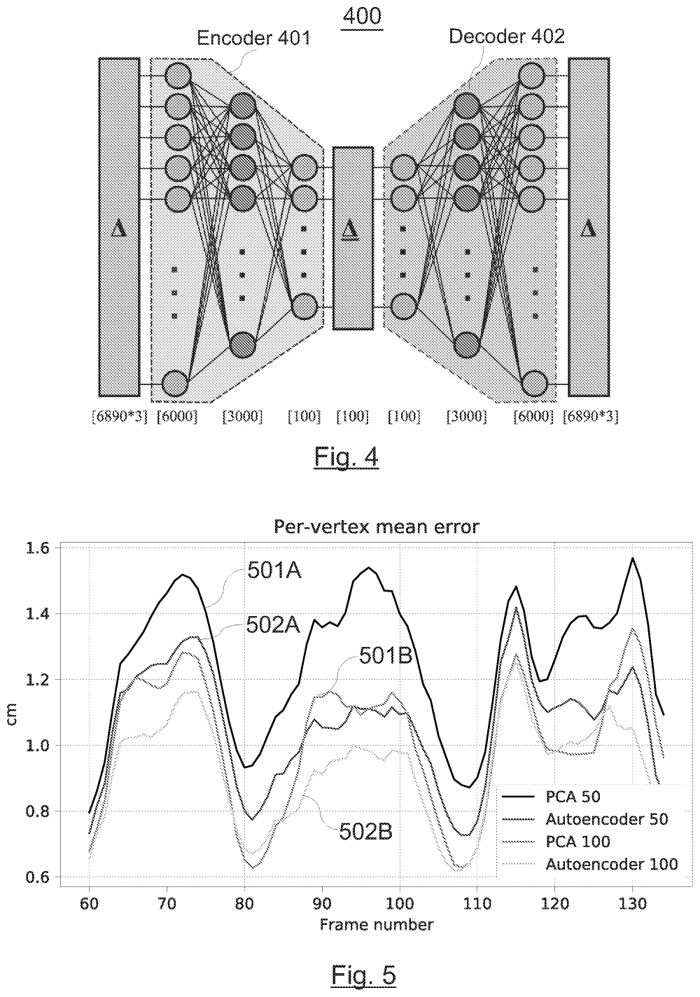

According to this embodiment, FIG. 5 provides an illustrative comparative analysis with plots of the per-vertex mean error of the dynamic blendshapes of the sequence 50002_running_on_spot (not used for training) reconstructed with PCA (lines 501A and 501B) and our autoencoder (lines 502A and 502B). Intuitively, higher error in the plot of FIG. 5 corresponds to a latent space of a particular method that fails in reproducing the input mesh. The plot of FIG. 5 provides results for latent space of dimensions 50 (501A and 502A) and 100 (501B and 502B) for both PCA and an autoencoder according to embodiments of the invention. The autoencoder consistently outperforms PCA when using the same latent space dimensionality. Furthermore, the autoencoder according to one embodiment with dimension 50 (502A), performs similarly than PCA with dimension 100 (501), which demonstrates the richer nonlinear subspace obtained with the autoencoders according to the embodiments of the invention.

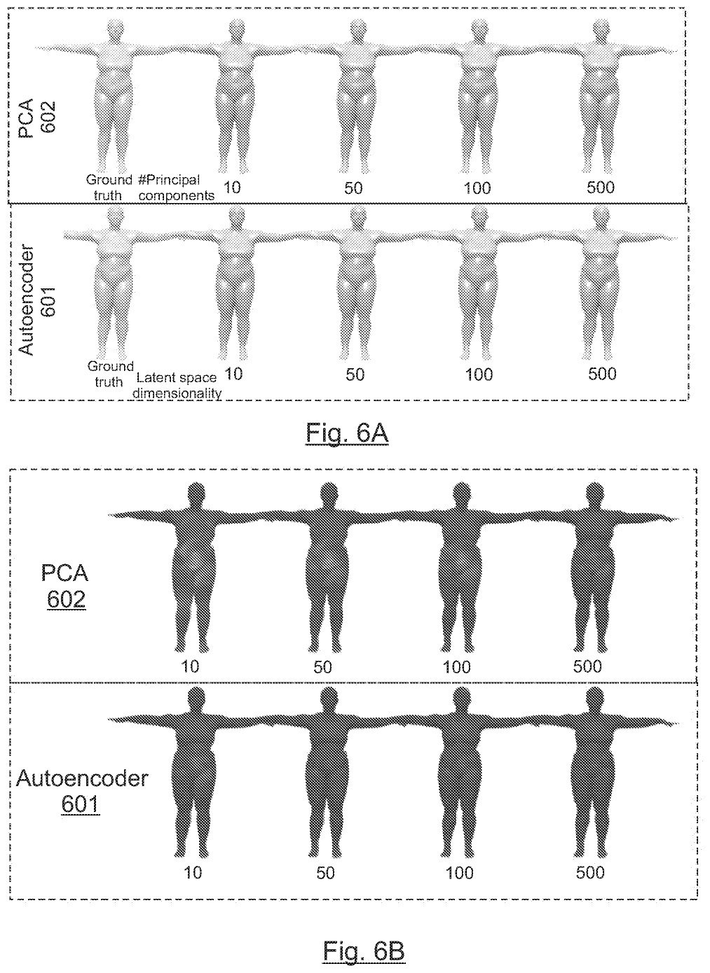

To illustrate the qualitative evaluation of the embodiments described above, FIG. 6A depicts one example of a reconstructed dynamic blendshape from sequence 50004_one_leg_jump of the test 4D dataset (Dyna) using PCA 602 and autoencoder-based embodiments 601 for a range of subspace dimensions (10, 50, 100, and 500). For illustration, the reconstruction error is also provided with a colormap in FIG. 6B, both for PCA 602 and autoencoder-based embodiments 601 for the corresponding subspace dimensions. The autoencoder-embodiments consistently outperform the PCA-based results in terms of reconstruction fidelity.

The soft-tissue regression methodology according to the embodiments described above was also evaluated. A quantitative evaluation using a leave-one-out cross-validation strategy on the 4D scan dataset was performed. The autoencoder and the regressor were trained on all except one sequence of the Dyna dataset [Pons-Moll et al. 2015], and the embodiments of the regression method was trained on the discarded sequence. These 4D scan datasets do not provide much pose redundancy across sequences (i.e. each sequence is a significantly different motion). Therefore, leaving one sequence out of the training set potentially affects the generalization capabilities of the learned model. Despite this, the tested embodiment provided robust predictions of soft-tissue dynamics on unseen motions. For comparison, SMPL, another vertex-based skinning method, was tested and compared with the embodiments of the present invention.

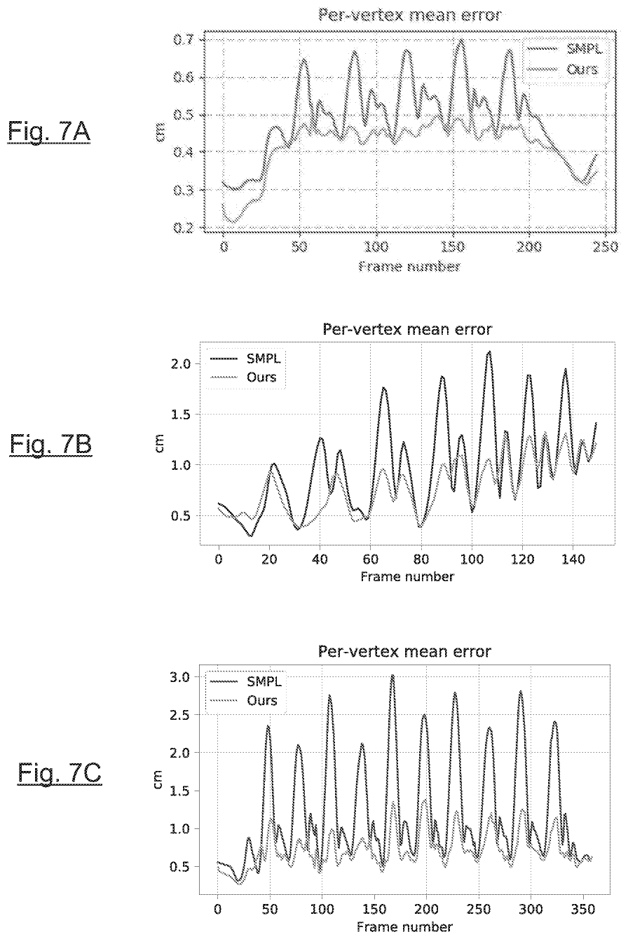

FIGS. 7A, 7B, and 7C depicts plots of the mean per-vertex error of the model according to embodiments of the invention and the ground truth 4D scans of the Dyna dataset. Following a “leave-one-out” cross validation strategy, the evaluated sequence in each plot is not part of the training set. In particular, FIG. 7A shows the mean error over all vertices per-frame in the 50004_one_leg_jump sequence, which results in a mean error of 0.40±0.06 cm, in contrast to the 0.51±0.12 cm SMPL error. To highlight the improvement in particularly non-rigid areas, such as belly and breast, FIGS. 7B and 7C show plots of the mean error only in those areas. Results demonstrate that the model according to embodiments of the invention outperform SMPL by significant margin: in sequence 50004_running_on_spot in FIG. 7B, our method (0.77±0.24 cm) significantly outperforms SMPL (1.13±0.52 cm); also in sequence 50004_jumping_jacks in FIG. 7C (ours 0.71±0.26 cm, SMPL 1.22±0.68 cm).

The soft-tissue regression results according to the embodiments of the invention were also evaluated both visually comparing to ground truth scans and by creating new animations from just skeletal MoCap sequences. FIG. 8 provides an illustrative visual comparison of SMPL results 802A and 803A to results according to the disclosed embodiments 802B and 803B with respect to the 4D scan ground truth sequences 801. In particular, FIG. 8 shows one frame of the 50004_one_leg_jump sequence 801 in both plain geometry (802A and B) and colormap (803A and B) visualizations. While SMPL fails in reproducing dynamic details in belly and breast areas (with errors of up to 5 cm in 803A), our method successfully reproduces such nonlinear soft-tissue effects.

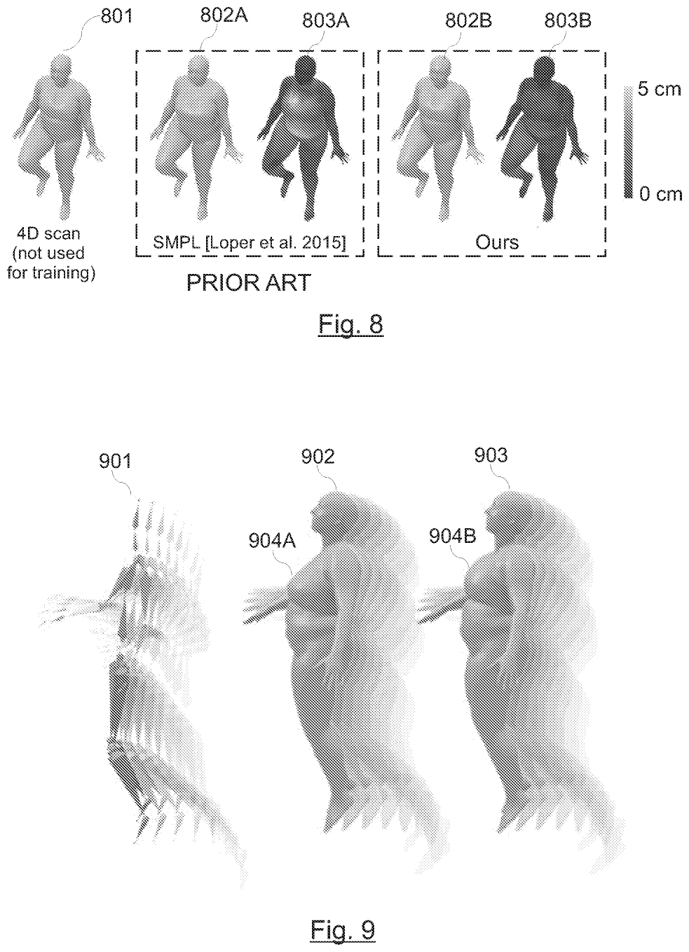

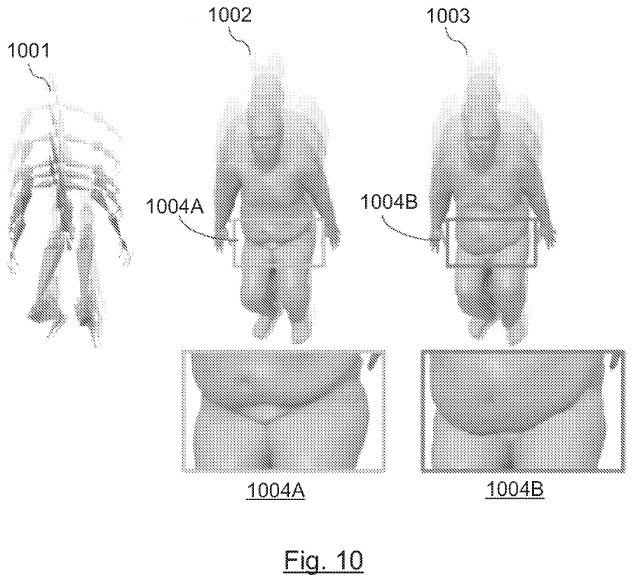

FIGS. 9 and 10 illustrate dynamic sequences created from skeletal MoCap data from publicly available datasets such as CMU [CMU 2003] and Total Capture [Trumble et al. 2017] using SMPL and the disclosed simulation methodology. For example, in FIG. 9, from the skeletal input 901, the SMPL model 902 shows lower performance in highly non-rigid areas such as the breast 904A affected by the ongoing motion and deformed less realistically. The result of the model according to embodiments of the invention 903 shows a more realistic soft-tissue performance in the non-rigid chest area 904B, with some upwards mobility due to the upwards motion of the skeletal input 901. Similarly, FIG. 10 illustrates a similar result for the non-rigid area of a human belly modeling a jumping motion. From the skeletal input 1001, the SMPL model 1002 shows lower performance in the belly area 1004A affected by the ongoing motion and deformed less realistically. The result of the model according to embodiments of the invention 1003 shows a more realistic soft-tissue performance in the non-rigid belly area 1004B, with some downwards mobility due to the downwards motion of the skeletal input 1001 illustrating a jump motion. Note that we show results for different skeleton hierarchies, which are initially converted to SMPL joint angle representation to be feed to our regression network. The inventors implemented embodiments of the described system and method in TensorFlow [Abadi et al. 2016] with Adam optimizer [Kingma and Ba 2014], and using a desktop PC with NVidia GeForce Titan X GPU. Training of the autoencoder took approximately 20 minutes, and training the soft-tissue regressor approximately 40 minutes. Once trained, a forward pass on the encoder took about 8 ms and the soft-tissue regressor about 1 ms. Overall, the embodiment of the system performed at real-time rates, including the time budget for standard skinning techniques to produce the input to the method. In future embodiments, with faster hardware components and additional memory, training and performance is expected to be improved.

As those in the art will understand, a number of variations may be made in the disclosed embodiments, all without departing from the scope of the invention, which is defined solely by the appended claims. It should be noted that although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general-purpose computer, a GPU, a processor, or the like.

Examples of computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a graphics processing unit (GPU), a plurality of microprocessors, CPUs, GPUs, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine in any combination and number.

One or more processors in association with software in a computer-based system may be used to implement methods of training and modeling in real-time autoencoders and regressors, including neural networks, according to various embodiments, as well as data models for soft-tissue simulations according to various embodiments, all of which improves the operation of the processor and its interactions with other components of a computer-based system. The system according to various embodiments may be used in conjunction with modules, implemented in hardware and/or software, such as a cameras, a video camera module, a videophone, a speakerphone, a vibration device, a speaker, a microphone, a television transceiver, a keyboard, a Bluetooth module, a radio unit, a liquid crystal display (LCD) display unit, an organic light-emitting diode (OLED) display unit, a digital music player, a media player, a video game player module, an Internet browser, and/or any wireless local area network (WLAN) module, or the like.

The following references include those cited above and are provided for background and are incorporated herein by reference for all purposes:
Martin Abadi, Paul Barham, Jianmin Chen, Zhifeng Chen, Andy Davis, Jeffrey Dean, Matthieu Devin, Sanjay Ghemawat, Geoffrey Irving, Michael Isard, Manjunath Kudlur, Josh Levenberg, Rajat Monga, Sherry Moore, Derek G. Murray, Benoit Steiner, Paul Tucker, Vijay Vasudevan, Pete Warden, Martin Wicke, Yuan Yu, and Xiaoqiang Zheng. 2016. TensorFlow: A System for Large-scale Machine Learning. In Conference on Operating Systems Design and Implementation. 265-283.
Brett Allen, Brian Curless, and Zoran Popović. 2002. Articulated body deformation from range scan data. In ACM Transactions on Graphics (TOG), Vol. 21. ACM, 612-619.
Dragomir Anguelov, Praveen Srinivasan, Daphne Koller, Sebastian Thrun, Jim Rodgers, and James Davis. 2005. SCAPE: Shape Completion and Animation of People. In ACM Transactions on Graphics (TOG), Vol. 24. ACM, 408-416.
Jernej Barbic̆ and Doug L James. 2005. Real-time subspace integration for St. Venant-Kirchhoff deformable models. In ACM transactions on graphics (Proc. of SIGGRAPH), Vol. 24.982-990.
Federica Bogo, Javier Romero, Matthew Loper, and Michael J Black. 2014. FAUST: Dataset and evaluation for 3D mesh registration. In IEEE Conference on Computer Vision and Pattern Recognition (CVPR). 3794-3801.
Federica Bogo, Javier Romero, Gerard Pons-Moll, and Michael J. Black. 2017. Dynamic FAUST: Registering Human Bodies in Motion. In IEEE Conf. on Computer Vision and Pattern Recognition (CVPR).
Chris Budd, Peng Huang, Martin Klaudiny, and Adrian Hilton. 2013. Global non-rigid alignment of surface sequences. International Journal of Computer Vision 102, 1-3 (2013), 256-270.
Steve Capell, Seth Green, Brian Curless, Tom Duchamp, and Zoran Popovic̆. 2002. Interactive skeleton-driven dynamic deformations. In ACM Transactions on Graphics (Proc. of SIGGRAPH), Vol. 21. ACM, 586-593.
Yinpeng Chen, Zicheng Liu, and Zhengyou Zhang. 2013. Tensor-based Human Body Modeling. In IEEE Conference on Computer Vision and Pattern Recognition (CVPR). 105-112.
CMU. 2003. CMU: Carnegie-Mellon Mocap Database. In http://mocap.cs.cmu.edu.
Edilson De Aguiar, Leonid Sigal, Adrien Treuille, and Jessica K Hodgins. 2010. Stable spaces for real-time clothing. 29, 4 (2010), 106.
Andrew Feng, Dan Casas, and Ari Shapiro. 2015. Avatar reshaping and automatic rigging using a deformable model. In ACM SIGGRAPH Conference on Motion in Games. ACM, 57-64.
Katerina Fragkiadaki, Sergey Levine, Panna Felsen, and Jitendra Malik. 2015. Recurrent network models for human dynamics. In IEEE International Conference on Computer Vision (ICCV). 4346-4354.
Fabian Hahn, Sebastian Martin, Bernhard Thomaszewski, Robert Sumner, Stelian Coros, and Markus Gross. 2012. Rig-space physics. ACM Transactions on Graphics (Proc. SIGGRAPH) 31, 4 (2012).
Fabian Hahn, Bernhard Thomaszewski, Stelian Coros, Robert W Sumner, and Markus Gross. 2013. Efficient simulation of secondary motion in rig-space. In ACM SIG-GRAPH/Eurographics Symposium on Computer Animation. ACM, 165-171.
Nils Hasler, Carsten Stoll, Martin Sunkel, Bodo Rosenhahn, and H-P Seidel. 2009. A statistical model of human pose and body shape. In Computer Graphics Forum (Proc. of Eurographics), Vol. 28. 337-346.
Geoffrey E Hinton and Ruslan R Salakhutdinov. 2006. Reducing the dimensionality of data with neural networks. Science 313, 5786 (2006), 504-507.
David A Hirshberg, Matthew Loper, Eric Rachlin, and Michael J Black. 2012. Coregis-tration: Simultaneous alignment and modeling of articulated 3D shape. In European Conference on Computer Vision. Springer, 242-255.
Daniel Holden, Taku Komura, and Jun Saito. 2017. Phase-functioned Neural Networks for Character Control. ACM Transactions on Graphics (Proc. SIGGRAPH) 36, 4 (2017). Chun-Hao Huang, Benjamin Allain, Edmond Boyer, Jean-Sebastien Franco, Federico Tombari, Nassir Navab, and Slobodan Ilic. 2017. Tracking-by-detection of 3d human shapes: from surfaces to volumes. IEEE Transactions on Pattern Analysis and Machine Intelligence (TPAMI) (2017).
Alec Jacobson and Olga Sorkine. 2011. Stretchable and twistable bones for skeletal shape deformation. ACM Transactions on Graphics (TOG) 30, 6 (2011).
Doug L James and Christopher D Twigg. 2005. Skinning mesh animations. ACM Transactions on Graphics (TOG) 24, 3 (2005), 399-407.
Petr Kadlec̆ek, Alexandru-Eugen Ichim, Tiantian Liu, Jaroslav Kr̆ivánek, and Ladislav Kavan. 2016. Reconstructing personalized anatomical models for physics-based body animation. ACM Transactions on Graphics (Proc. SIGGRAPH Asia) 35, 6 (2016), 213.
Ladislav Kavan, Steven Collins, Jir̆i Z̆ára, and Carol O'Sullivan. 2008. Geometric skinning with approximate dual quaternion blending. ACM Transactions on Graphics (TOG) 27, 4 (2008).
Ladislav Kavan, P-P Sloan, and Carol O'Sullivan. 2010. Fast and efficient skinning of animated meshes. Computer Graphics Forum 29, 2 (2010), 327-336.
Meekyoung Kim, Gerard Pons-Moll, Sergi Pujades, Sungbae Bang, Jinwwok Kim, Michael Black, and Sung-Hee Lee. 2017. Data-Driven Physics for Human Soft Tissue Animation. ACM Transactions on Graphics, (Proc. SIGGRAPH) 36, 4 (2017).
Theodore Kim and Doug L James. 2012. Physics-based character skinning using multi-domain subspace deformations. IEEE Transactions on Visualization and Computer Graphics 18, 8 (2012), 1228-1240.
Diederik Kingma and Jimmy Ba. 2014. Adam: A method for stochastic optimization. arXiv preprint arXiv:1412.6980 (2014).
Paul G. Kry, Doug L. James, and Dinesh K. Pai. 2002. Eigenskin: real time large deformation character skinning in hardware. In ACM SIGGRAPH/Eurographics Symposium on Computer Animation (SCA). ACM, 153-159.
L'ubor Ladicky, SoHyeon Jeong, Barbara Solenthaler, Marc Pollefeys, and Markus Gross. 2015. Data-driven Fluid Simulations Using Regression Forests. ACM Trans. Graph. 34, 6, Article 199 (October 2015), 9 pages. https://doi.org/10.1145/2816795.2818129
Binh Huy Le and Zhigang Deng. 2014. Robust and accurate skeletal rigging from mesh sequences. ACM Transactions on Graphics (TOG) 33, 4 (2014).
John P. Lewis, Matt Cordner, and Nickson Fong. 2000. Pose Space Deformation: a unified approach to shape interpolation and skeleton-driven deformation. In Conference on Computer Graphics and Interactive Techniques. 165-172.
Libin Liu, KangKang Yin, Bin Wang, and Baining Guo. 2013. Simulation and Control of Skeleton-driven Soft Body Characters. ACM Trans. Graph. 32, 6, Article 215 (November 2013), 8 pages. https://doi.org/10.1145/2508363.2508427
Matthew Loper, Naureen Mahmood, Javier Romero, Gerard Pons-Moll, and Michael J. Black. 2015. SMPL: A Skinned Multi-Person Linear Model. ACM Trans. Graphics (Proc. SIGGRAPH Asia) 34, 6 (2015), 248:1-248:16.
Nadia Magnenat-Thalmann, Richard Laperrire, and Daniel Thalmann. 1988. Joint-dependent local deformations for hand animation and object grasping. In Proceed-ings on Graphics interfaceâĂŹ88.
Timothy Masters. 1993. Practical neural network recipes in C++. Morgan Kaufmann. Leonid Pishchulin, Stefanie Wuhrer, Thomas Helten, Christian Theobalt, and Bernt Schiele. 2017. Building statistical shape spaces for 3D human modeling. Pattern Recognition 67 (2017), 276-286.
Gerard Pons-Moll, Javier Romero, Naureen Mahmood, and Michael J Black. 2015. Dyna: A model of dynamic human shape in motion. ACM Transactions on Graphics, (Proc. SIGGRAPH) 34, 4 (2015).
Eftychios Sifakis, Igor Neverov, and Ronald Fedkiw. 2005. Automatic Determination of Facial Muscle Activations from Sparse Motion Capture Marker Data. ACM Trans. Graph. 24, 3 (July 2005), 417-425. https://doi.org/10.1145/1073204.1073208
Matthew Trumble, Andrew Gilbert, Charles Malleson, Adrian Hilton, and John Collo-mosse. 2017. Total Capture: 3D Human Pose Estimation Fusing Video and Inertial Sensors. In BMVC17.
Rodolphe Vaillant, Loïc Barthe, Gaël Guennebaud, Marie-Paule Cani, Damien Rohmer, Brian Wyvill, Olivier Gourmel, and Mathias Paulin. 2013. Implicit skinning: real-time skin deformation with contact modeling. ACM Transactions on Graphics (TOG) 32, 4 (2013), 125.
Xiaohuan Corina Wang and Cary Phillips. 2002. Multi-weight enveloping: least-squares approximation techniques for skin animation. In ACM SIGGRAPH/Eurographics Symposium on Computer animation (SCA). 129-138.
Hongyi Xu and Jernej Barbic̆. 2016. Pose-Space Subspace Dynamics. ACM Transactions on Graphics (Proc. SIGGRAPH) 35, 4 (2016).

What is claimed is:

1. A system for computer-based modeling of a body comprising:
a surface skinning module for adding skin surface elements to a frame of skeletal input representative of a pose of the body; and
a soft-tissue regression module configured to add nonlinear soft-tissue dynamics to the skin surface elements and provide an output mesh representative of the body at the pose in the skeletal input, the soft-tissue regression module comprising a neural network trained from observations to predict 3-dimensional offsets.

2. The system of claim 1 wherein the body corresponds to one of a human body, an animal body, a character in a movie, a character in a video game, or an avatar.

3. The system of claim 2 wherein the avatar represents a customer.

4. The system of claim 1 further comprising an autoencoder module configured to reduce by two or more orders of magnitude the dimensionality of a plurality of three-dimensional offsets for a plurality of vertices in the skin surface elements, the autoencoder module comprising a combination of linear and non-linear activation functions.

5. The system of claim 4 wherein the autoencoder module comprises at least three layers, wherein at least two non-successive layers comprise non-linear activation functions.

6. The system of claim 1 wherein the neural network is trained from a set of observations in a set of three-dimensional input meshes representative of a plurality of poses for a reference body.

7. The system of claim 4 wherein the autoencoder module is trained from a set of observations in a set of three-dimensional input meshes representative of a plurality of poses for a reference body.

8. The system of claim 1 wherein the neural network comprised by the soft-tissue regression module is trained to predict 3-dimensional offsets from velocities and accelerations derived from prior frames of the skeletal input.

9. The system of claim 4 wherein the soft-tissue regression module is configured to add the nonlinear soft-tissue dynamics to the skin surface elements using the output of the one or more activation functions.

10. A method for computer-based modeling of a body comprising:
adding skin surface elements to a frame of skeletal input representative of a pose of the body;
adding nonlinear soft-tissue dynamics to the skin surface elements with a neural network trained from observations to predict 3-dimensional offsets; and
providing an output mesh representative of the body at the pose in the skeletal input.

11. The method of claim 10 wherein the body corresponds to one of a human body, an animal body, a character in a movie, a character in a video game, or an avatar.

12. The method of claim 11 wherein the avatar represents a customer.

13. The method of claim 10 further comprising reducing by two or more orders of magnitude the dimensionality of a plurality of three-dimensional offsets for a plurality of vertices in the skin surface elements, including applying one or more non-linear activation functions.

14. The method of claim 13 wherein the reducing comprises applying the one or more non-linear activation functions includes a second non-successive non-linear activation function.

15. The method of claim 10 wherein further comprising training an autoencoder from a set of observations in a set of three-dimensional input meshes representative of a plurality of poses for a reference body.

16. The method of claim 10 wherein further comprising training a neural network from a set of observations in a set of three-dimensional input meshes representative of a plurality of poses for a reference body.

17. The method of claim 11 wherein adding the nonlinear soft-tissue dynamics to the skin surface elements comprises processing the output of the one or more activation functions.

18. The method of claim 10 wherein in the adding nonlinear soft-tissue dynamics to the skin surface elements, the neural network is trained from observations to predict 3-dimensional offsets from velocities and accelerations derived from prior frames of the skeletal input.

19. A system for computer-based modeling of a body comprising:
means for adding skin surface elements to a frame of skeletal input representative of a pose of the body; and
means for adding nonlinear soft-tissue dynamics to the skin surface elements with a neural network trained from observations to predict 3-dimensional offsets; and
means for providing an output mesh representative of the body at the pose in the skeletal input.

20. The system of claim 19 wherein the body corresponds to one of a human body, an animal body, a character in a movie, a character in a video game, or an avatar.

21. The system of claim 20 wherein the avatar represents a customer.

22. The system of claim 19 further comprising means for reducing by two or more orders of magnitude the dimensionality of a plurality of three-dimensional offsets for a plurality of vertices in the skin surface elements, including applying one or more non-linear activation function.

23. The system of claim 22 wherein the means for reducing includes applying a first non-linear activation function and a second non-successive non-linear activation function.

24. The system of claim 22 wherein at least one of the means for reducing or the means for adding nonlinear soft-tissue dynamics are trained from a set of observations in a set of three-dimensional input meshes representative of a plurality of poses for a reference body.

25. The system of claim 22 wherein the means for adding the nonlinear soft-tissue dynamics to the skin surface elements comprises processing the output of the activation functions.

26. The method of claim 19 wherein the neural network comprised by the means for adding nonlinear soft-tissue dynamics is trained from observations to predict 3-dimensional offsets from velocities and accelerations derived from prior frames of the skeletal input.

27. A system for computer-based modeling of a body comprising computer readable media including instructions that when executed by one or more processors cause the one or more processors to implement a set of software modules comprising:
a surface skinning module for adding skin surface elements to a frame of skeletal input representative of a pose of the body; and
a soft-tissue regression module configured to add nonlinear soft-tissue dynamics to the skin surface elements and provide an output mesh representative of the body at the pose in the skeletal input, the soft-tissue regression module comprising a neural network trained from observations to predict 3-dimensional offsets.

28. The system of claim 27 wherein the body corresponds to one of a human body, an animal body, a character in a movie, a character in a video game, or an avatar.

29. The system of claim 28 wherein the avatar represents a customer.

30. The system of claim 27 further comprising an autoencoder module configured to reduce by two or more orders of magnitude the dimensionality of a plurality of three-dimensional offsets for a plurality of vertices in the skin surface elements, the autoencoder module comprising one or more non-linear activation functions.

31. The system of claim 30 wherein the autoencoder module comprises at least three layers, wherein at least two non-successive layers comprise non-linear activation functions.

32. The system of claim 30 wherein the autoencoder module is trained from a set of observations in a set of three-dimensional input meshes representative of a plurality of poses for a reference body.

33. The system of claim 27 wherein the neural network is further trained from a set of observations in a set of three-dimensional input meshes representative of a plurality of poses for a reference body.

34. The system of claim 30 wherein the soft-tissue regression module is configured to add nonlinear soft-tissue dynamics to the skin surface elements using the output of the one or more activation functions.

35. The system of claim 27 wherein the neural network comprised in the soft-tissue regression module is trained from observations to predict 3-dimensional offsets from velocities and accelerations derived from prior frames of the skeletal input.

36. A method for computer-based modeling of a body comprising:
adding skin surface elements to a frame of skeletal input representative of a pose of the body;
reducing by two or more orders of magnitude the dimensionality of a plurality of three-dimensional offsets for a plurality of vertices in the skin surface elements, including applying at least one non-linear activation function; and
providing an output mesh representative of the body at the pose in the skeletal input.

37. The method of claim 36 further comprising adding nonlinear soft-tissue dynamics to the skin surface elements.

38. The method of claim 37 wherein the adding nonlinear soft-tissue dynamics includes a neural network trained from observations to predict 3-dimensional offsets.

39. The method of claim 36 wherein the reducing step comprises applying at least three layers of activation functions, wherein at least two non-successive layers comprise non-linear activation functions.

40. The method of claim 36 wherein the body corresponds to one of a human body, an animal body, a character in a movie, a character in a video game, or an avatar.

41. The method of claim 40 wherein the avatar represents a customer.
